(19) United States
(12) Patent Application Publication
(10) Pub. No.: US 2009/0294471 A1
(43) Pub. Date: Dec. 3, 2009

(54) PROGRAMMABLE AEROSOL DISPENSER

(75) Inventor: Lee PAIGE, Richmond Hill (CA)

Correspondence Address: LANG MICHENER, BROOKFIELD PLACE, P.O. BOX 747, SUITE 2500, 181 BAY STREET, TORONTO, ON, M5J 2T7, CA

(73) Assignee: K-G PACKAGING INC., Concord (CA)

(21) Appl. No.: 12/473,738

(22) Filed: May 28, 2009

Related U.S. Application Data
(60) Provisional application No. 61/056,895, filed on May 29, 2008.

(51) Int. Cl. B67D 5/22; B67D 5/08; B67D 1/07; G04C 23/00

(52) U.S. Cl. 222/36; 222/192; 222/52; 222/646; 222/649

(57) ABSTRACT

Disclosed is an aerosol dispensing for dispensing a metered amount of an aerosol for dispersion in an area of use unit having a main body. The aerosol dispensing unit according to the present invention includes a reservoir within the main body for holding an aerosol, an outlet in fluid communication with the reservoir and arranged to dispense a metered amount of the aerosol upon activation of a trigger device, and an audio output system adapted to play a sound in response to the activation of said trigger device. The aerosol is preferably one of a deodorizing agent and a disinfectant. The trigger device is adapted to be activated either by a sensor used to detect a person within a given area, and activate the trigger device upon detection of the person, or alternatively, a timer is operatively connected to the trigger device to dispense the metered amount of aerosol and play the sound at timed intervals.

### FIELD OF THE INVENTION

The present invention relates to the field of aerosol dispensers, and more particularly, to a programmable aerosol dispenser with an audio output system.

### BACKGROUND OF THE INVENTION

The increase in public awareness and sensitivity to issues of hygiene and cleanliness has resulted in disinfectant dispensers becoming a ubiquitous item in many public locations, particularly restrooms. Most commonly, an aerosol dispenser that dispenses an air freshener, an anti-bacterial agent, a deodorant agent, or some combination thereof is located in a relatively unobtrusive spot near the ceiling of a restroom. Other aerosol dispensers are also used to dispense an insecticide in agricultural areas where insects are problematic.

Given the increased presence of these dispensers, there is a need to develop a dispenser that provides additional utility, and can be used to further promote public awareness to issues of hygiene and/or cleanliness.

There have been several attempts in the prior art to address the aforementioned need. One such example is found in U.S. Pat. No. 6,315,163 issued to Shu (“Shu”). Shu discloses a pressure-activated dispenser (such as a liquid soap dispenser) with a mechanically-triggered sound-emitting device which is activated upon use of the dispenser. The sound emitting device is built into the base of the dispenser such that the ‘pump’ activation of the dispenser also triggers the sound emitting device. The Shu dispenser is limited in that the user must mechanically activate the dispenser to trigger the sound-emitting device, thus limiting the potential applications and benefits of the sound emission from the dispenser. The Shu device is further limited in that it cannot be adapted to be mounted near the ceiling of a restroom, as the requirement mechanical activation makes this unfeasible.

Another attempt is found in U.S. Pat. No. 5,695,091 issued to Winings et al. (“Winings”). Winings discloses a dispenser for disinfectant (e.g. hand soap) with a proximity sensor that provides a visual and/or audio cue (i.e. a light or a buzzer tone) to remind a user to use the dispenser to disinfect. The dispenser also includes a second sensor to detect the user's hands and automatically dispense the disinfectant soap. Winings also discloses a built-in tracking system to compare usage of the dispenser against the number of reminders played. The Winings dispenser is limited in that the user must trigger the sensor to activate the cue, and activation is thus limited in range. Additionally, Winings requires a second activation by the user to perform its dispensing function.

Yet another attempt is found in U.S. Pat. No. 6,347,414 issued to Contadini et al. (“Contadini”). Contadini discloses a sanitizing dispensing system which uses a sensor to track the number of people in an area and automatically dispenses a sanitizing agent when the number exceeds a pre-determined limit. The patent further discloses a variable time-based dispensing system based on the number of people detected in an area. Contadini is designed to track dispenser uses and does not include or disclose any form of audio reminder or indicator with the dispenser.

There is therefore a need for a dispenser that provides for the programmable recording and playback of audio messages in conjunction with its dispensing function. There is a further need in the art for an aerosol dispensing unit which can be used to convey informative messages, promotional messages, or otherwise promote general hygiene, cleanliness, and safety at a workplace.

It is an object of this invention to partially or completely fulfill one or more of the above-mentioned needs.

### SUMMARY OF THE INVENTION

In accordance with a first embodiment of the present invention, there is disclosed an aerosol dispensing for dispensing a metered amount of an aerosol for dispersion in an area of use. The aerosol dispensing unit according to the present invention includes a reservoir within the main body for holding an aerosol, an outlet in fluid communication with the reservoir and arranged to dispense a metered amount of the aerosol upon activation of a trigger device, and an audio output system integrated with the main body. Preferably, the audio output system is adapted to play a sound in response to the activation of said trigger device. The aerosol is preferably one of a deodorizing agent and a disinfectant.

In one aspect of the invention, the trigger device is adapted to be activated either by a sensor used to detect a person within a given area, or alternatively, a timer is operatively connected to the trigger device to dispense the metered amount of aerosol and play the sound at timed intervals.

According to another aspect of the present invention, the aerosol dispensing unit includes a memory unit for storing at least one audio message, and wherein the sound is selected from the at least one audio message. The aerosol dispensing unit further comprises a programming device in communication with the memory unit for programming the selection of the sound from the at least one audio message on the memory unit. The at least one audio message preferably includes a plurality of audio messages, and the programming device is preferably programmed to select the sound from the plurality of audio messages each time said trigger device is activated. According to another aspect of the present invention, the aerosol dispensing unit includes an interface for connecting the programming device to a computer

According to another aspect of the present invention, the sound is selected based on a random selection, a sequential selection, a pre-determined ordered selection, a timed selection, or some combination thereof, of said plurality of audio messages. The plurality of audio messages may include one or more of an advertisement, a sanitary-related reminder message, a safety reminder message, an informative message, or a combination thereof.

According to another embodiment of the present invention, the aerosol dispensing unit includes a recording device integrated with the main body, and operatively connected to the memory unit, for recording the at least one audio message.

According to a further embodiment of the present invention, the aerosol dispensing unit includes a wireless communication device for receiving the at least one audio message from an off-site source. In this embodiment, the at least one audio recording may be broadcast live to the wireless communication device and played via said audio output system. The wireless communication device may further be adapted to transmit the at least one audio message to one or more wireless speakers in close proximity to the aerosol dispensing unit. The at least one audio message received by the wireless communication device may comprise one of an advertisement, a news broadcast and a radio station feed.

According to another embodiment of the present invention, the aerosol dispensing unit includes a spray counter, in communication with the reservoir and the programming device, for counting the number of times the trigger device has been activated; said programming device adapted to determine the amount of aerosol remaining in said reservoir based on the number of times the trigger device has been activated; and the programming device is programmed to indicate a low level of aerosol remaining by one of a visual indicator and an audio message.

According to another aspect of the present invention, the programming device is adapted to (a) determine the presence of a person in an area from the sensor detection, (b) activate the trigger device for a pre-determined time, and (c) initiate the sound playing from the audio output system. Additional steps may include (d) producing a delay prior to determining the presence of another person, and (e) repeating steps (a) to (d) from above.

According to an alternate aspect of the present invention, the programming device is adapted to (a) determine the presence of a person in an area from the sensor detection, (b) activate the trigger for a pre-determined time, and (c) initiate the sound playing from the audio output system, (d) determine the absence of the person from the area, (e) stop the sound playing from the audio system, (f) determine the presence of a subsequent person in the area from the sensor detection, (g) activate the trigger for a pre-determined time, (h) initiate the sound playing from the audio output system, and (i) repeat steps (e) to (i) as herein described.

### BRIEF DESCRIPTION OF THE DRAWINGS

The invention will now be described in more detail, by way of example only, with reference to the accompanying drawings, in which like numbers refer to like elements, wherein:

FIG. 1 is a perspective view of an aerosol dispensing unit according to a preferred embodiment of the present invention;

FIG. 2 is a schematic view of the internal elements of the aerosol dispensing unit of FIG. 1 according to a first embodiment of the present invention;

FIG. 3 is a schematic view of the internal elements of the aerosol dispensing unit of FIG. 1 according to a second embodiment of the present invention;

FIG. 4 is a flowchart showing one aspect of the operation of the aerosol dispensing unit of FIG. 3; and,

FIG. 5 is a flowchart showing a second aspect of the operation of the aerosol dispensing unit of FIG. 3.

### DETAILED DESCRIPTION OF THE PREFERRED EMBODIMENTS

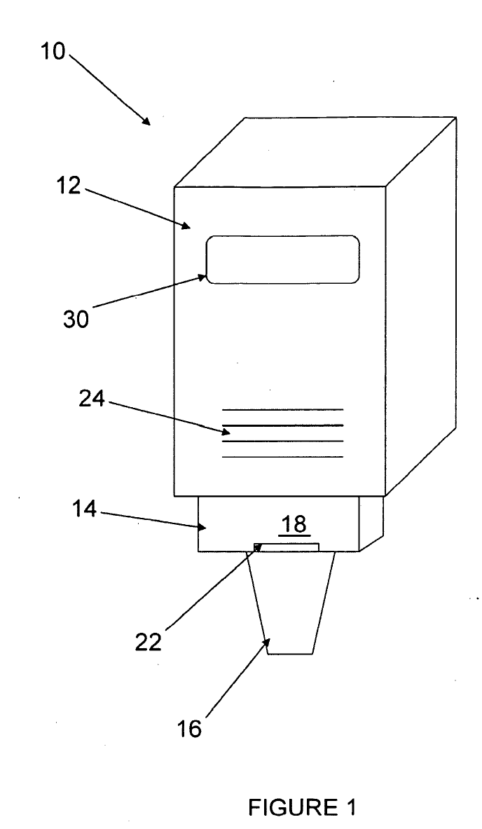

Referring to FIG. 1, there is shown an aerosol dispensing unit 10 according to a preferred embodiment of the present invention. The aerosol dispensing unit 10 generally comprises a main body 12, having a reservoir 14 located therein, and an outlet 16 in fluid communication with the reservoir 14, and arranged to dispense a metered amount of an aerosol 18 upon activation of a trigger device 22. According to the present invention, there is provided an audio output system 24 position within said main body 12. Preferably, the audio output system 24 is adapted to play a sound in response to activation of the trigger device 22. The aerosol dispensing unit 10 of the present invention is preferably adapted to dispense a deodorizing agent, or a sanitizing agent.

The aerosol dispensing unit 10 is preferably of the type mounted on a ceiling, or wall, of a public area, such as a public washroom, and is adapted to dispense the metered amount of the aerosol 18 as would be required to deodorize or sanitize the public area. The present invention is not limited to a particular type of aerosol dispenser. The mechanical operation of aerosol dispensers which allow for metered amounts of an aerosol to be dispensed are well known in the art, and is not described in detail herein. Specifically, activation of the trigger device 22 may be accomplished by any means known in the art, including, but not limited to mechanical activation and electrical activation, as will be apparent from the description below.

The audio output system 24 may comprise any system or device for playing sounds or messages, and preferably includes one or more speakers on an exterior of the aerosol dispensing unit 10. The sound output by the audio output system 24 may be any sound, including but not limited to, an unobtrusive sound to indicate that a metered amount of aerosol has been dispensed, an indication that the reservoir is below a certain minimum level and that the aerosol within the reservoir needs to be replenished, an informative message (“remember to wash your hands”), a commercial message (“buy more Brand X soap”), a promotional message (“do not forget to get your Jazz night tickets”) and/or a safety/security message (“always wear eye protection in plant areas”). Preferably, the sound is a message directed at people in the public area. Reference is made throughout the description to a message and a sound, however it will be understood that the two terms may be used interchangeably and are not exclusive of each other. Generally, the sound may include a portion of the message, or the entire message itself.

The trigger device 22 is preferably adapted to be activated according to one of two methods: 1) on a regular basis, according to a timer 20 which triggers the dispenser 10 on a pre-determined schedule, or 2) in response to a sensor 120 detecting the presence of a person, as will be described in more detail below.

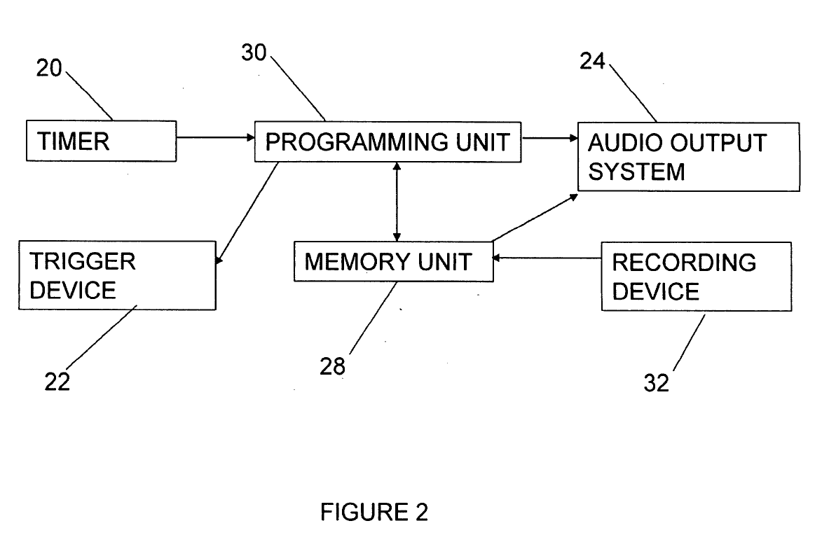

As shown with reference to FIGS. 1 and 2, the aerosol dispensing unit 10 may include a timer 20 operatively connected to the trigger device 22 arranged to dispense the metered amount of the aerosol 18, and play the sound at timed intervals. Such time intervals may be constant throughout the day, or may be pre-determined based on the number of people expected in the area at particular times over the course of the day.

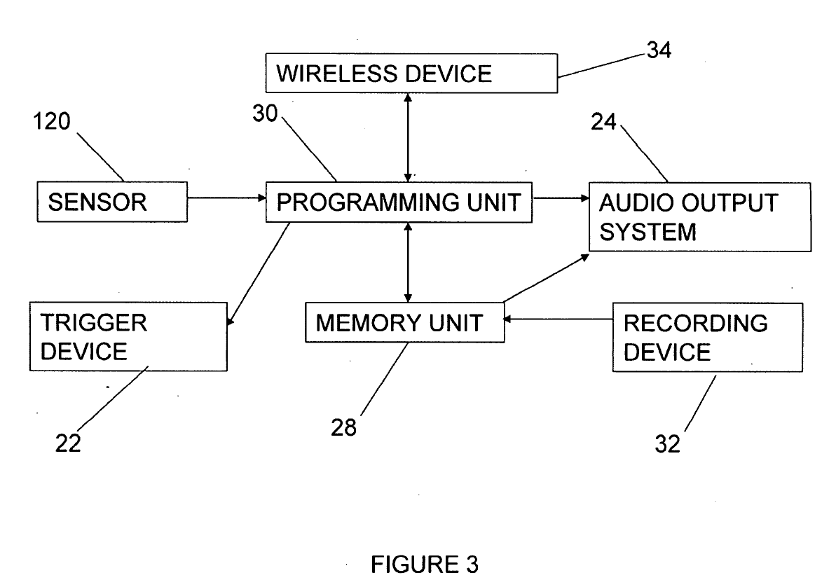

Preferably, as shown with reference to FIGS. 1 and 3, the aerosol dispensing unit 10 includes a sensor 120 for detecting the presence of a person in a particular area. According to this embodiment, the sensor 120 is operatively connected to the trigger device 22 such that when the sensor 120 detects a person in the area, the trigger device 22 is activated to dispense the metered amount of aerosol 18 and play the sound via the audio output system 24. Optionally, a delay may be provided between the time the sensor 120 detects a person and when the trigger device 22 is activated, and optionally, a further delay before the sound is played.

The aerosol dispensing unit 10 may further include a memory unit 28 for storing at least one audio message. This allows a bank of audio messages to be stored on the aerosol dispensing unit 10 and the sound being played is selected from the at least one audio message. The memory unit 28 may be written to, to store a digitized or analogue audio recording, either temporarily or permanently, and is readable such that the stored recording may be read and played back by the audio output system 24. The memory unit 28 may be an EPROM (erasable programmable read only memory) unit, but may alternatively be a PROM (programmable read only memory) unit. Other possible memory types include flash memory which can be easily written to using an onboard programming unit 30, or a receptor to receive memory cards, including, but not limited to SD and xD cards. The type of memory unit 28 is not limited to those discussed above and may comprise any form of memory which can be integrated within the main body 12 of the aerosol dispensing unit 20, and can communicate with a programming unit 30 as described below.

In communication with the memory unit 28, is a programming device 30 for programming the selection of the sound or message to be played from the at least one audio message stored on the memory unit 28. Typically, a plurality of audio messages will be stored on the memory unit 28 and the programming device 30 will be adapted to select a message, or a portion of a message, stored on the memory unit 28 to be played by the audio output system 24 each time the trigger device 22 is activated. The programming device 30 may be adapted to select the sound to be played in any manner, including, but not limited to, a random selection, a sequential selection, a pre-determined ordered selection, a timed selection, or some combination of the above.

The programming device 30 may be any programming device and may optionally include a keypad, a visual display, an internal processor, or a microcomputer. Alternatively, the programming device may include a communications port for communication and programming with a computer. Such communications port may be a USB, or similar port. Wireless communications between a computer and the programming device may also be provided. The programming device may further be adapted for communications with a PDA, a cellular telephone, or other mobile communications device which may be used to load instructions into the programming device or to load sounds/messages onto the memory unit 28 via the programming device 30.

In one example, the plurality of stored messages includes a number of advertisements and promotional messages, one of which is randomly selected to be played each time the trigger device 22 is activated. Alternatively, the advertisements can be played sequentially to ensure each message is played an equal number of times. In another example, the plurality of stored messages may be work related, and played depending on the time of day, or based on a reminder which needs to be played more often than others. For example, during morning hours, the message played may comprise a reminder of safety regulations, such as, “Please, remember that safety helmets must be worn at all times on the shop floor.” Towards the end of the day, the message may be adapted to relay; “Please tidy up your work stations before leaving the worksite” or a promotional message, “Do not forget that tonight is Jazz night.” It will be understood by those skilled in the art that the messages may be adapted for any particular job site, and programmed in any manner required. The present invention is not to be limited by the particular order of messages played, the type of messages, or the environment in which the device is used. Generally, the stored messages include one or more of an advertisement, a sanitary-related reminder message, a safety reminder message, an informative message, or a combination thereof.

In another aspect of the present invention, the aerosol dispensing unit 10 preferably includes a recording device 32 integrated with main body 12, and operatively connected to the memory unit 28, for recording the at least one audio message which is stored on the memory unit 28. The recording device 32 may be used to record messages directly onto the memory unit 28, and generally includes a microphone and sound processing capability to convert a recorded sound to a format storable on the memory unit 28.

Alternatively, a wireless communication device 34 may be provided such that messages may be recorded at a distant location, and sent wirelessly to the aerosol dispensing unit 10, for storage on memory unit 28. The inclusion of the wireless communication device 34 also allows live broadcasting of the audio message to be played by the audio output system 24. Such live broadcasting would further allow for emergency messages or workplace announcements to be broadcast via the aerosol dispensing unit 10. In use, the message would only be broadcast when the trigger device 12 is activated, and preferably when the sensor 120 detects the presence of a person. Preferably, when live messages are broadcast, the message is played for an extended period of time allowing the entire message to be heard. Additional functionality of the wireless communication device 34 may include the transmission of the audio message to one or more wireless speakers located within the same general area of the aerosol dispensing unit 10, thus ensuring that the message is heard throughout the general area. Alternatively, the audio output system 24 can be linked wirelessly to a news service or similar regularly updated broadcast service. In this example, the messages played would be longer, such as between one and five minutes, and preferably triggered to play on a regular basis.

A spray counter (not shown) may be provided, in communication with the reservoir 14 and the programming device 30, for determining the amount of aerosol remaining in the reservoir 14. In this embodiment, the programming device 30 may be programmed to determine the amount of aerosol remaining in the reservoir based on the number of sprays counted and the amount of aerosol dispensed each spray. Such spray counters are well known in the art, and the particular type of sensor is not limited by the present invention. The programming device 30 may then be programmed to play the message indicating a low level of aerosol remaining in the reservoir 14 or alternatively, a visual indication may be provided to indicate a low level of aerosol, such as a light which is activated based on the number of sprays counted. The light may be provided on a visual display of the programming device.

Further, any means of determining a low level of aerosol remaining the reservoir 14 may be employed, which allows the communication of the low level to the programming device 30, and subsequent wireless transmission of the need to replenish the reservoir 14. Alternatively, if a wireless communication device is not provided, the programming device 30 may be adapted to play a message already stored on the memory unit 28 indicating the need to replenish the reservoir 14.

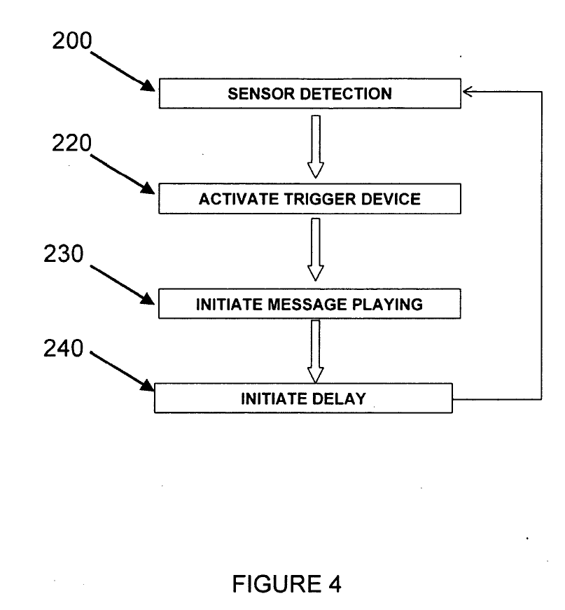

The operation of one embodiment will now be described. The aerosol dispensing unit 10 according to this embodiment is shown in FIG. 3 and includes at least the programming device 30 in communication with the sensor 120, the audio output system 24, and the trigger device 12. Referring to FIG. 4, the programming device 30 is adapted to first, in step 200, determine the presence of a person in an area from the sensor detection. Once, the presence of the person has been detected, step 220 requires the activation of the trigger device 22, to dispense the metered amount of aerosol.

In step 230, the programming device 30 initiates the sound playing from the audio output system 24 for a pre-determined time. The particular sound played may be an previously mentioned in this description, or those similar sounds and/or messages as would be apparent to those skilled in the art. The programming device 30 then produces a delay, in step 240, prior to determining the presence of another person. This delay allows for the initially detected person to leave the area and prevents multiple activations of the trigger device 22 and sound playing based on the same person being detected in short periods of time. These steps can then be repeated.

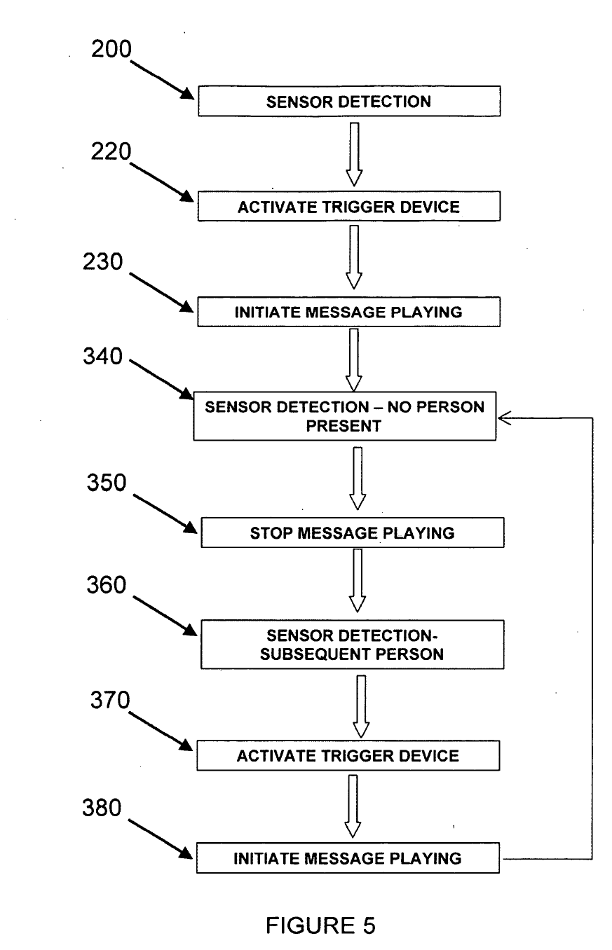

Alternatively, as shown in FIG. 5, after step 230, the programming device 30 may deactivate the trigger device 22 in step 340, including, but not limited to, for example, using entry and exit sensors (not shown) for a given area. Optionally, in step 350, once it has been determined that the person has exited the area, the sound or message being played by the audio output system 24, even if the message has not been completed. In step 360, the presence of another person is detected and then in step 370, the trigger device 22 is activated again to dispense the metered amount of the aerosol. Next, the programming device 30 determines a subsequent sound or message to be played and plays it in step 380. The sound or message played in step 380 may or may not be the same as the message played in step 230, in accordance with the aforementioned teachings on determining the sound to play. Finally, steps 340 to 380 are repeated.

Such operation as described with respect to FIGS. 4 and 5 are provided for example only, and are not to be considered limiting. The programming device 30 may be configured to apply various combinations of sound and/or message determination, in response to either the timer response, or response from the sensor as would be apparent from the teachings of the present description.

This concludes the description of a presently preferred embodiment of the invention. The foregoing description has been presented for the purpose of illustration and is not intended to be exhaustive or to limit the invention to the precise form disclosed.

Other modifications and alterations may be used in the design and manufacture of other embodiments according to the present invention without departing from the spirit and scope of the invention, which is limited only by the accompanying claims. For example, the invention may be applied in aerosol units in other environments, and have messages adapted for such environments. For example, the aerosol unit according the present invention may be used in a hospital environment and may include messages reminding people to use a hand sanitizer, or include public service announcements related to hospital professional and/or social events. It will be further understood that the present invention may optionally be applied to other fluid dispensers, including soap dispensers.

What is claimed is:

1. An aerosol dispensing unit for dispensing a metered amount of an aerosol for dispersion in an area of use, said aerosol dispensing unit comprising:
i. a main body,
ii. a reservoir within said main body for holding an aerosol,
iii. an outlet in fluid communication with said reservoir and arranged to dispense a metered amount of the aerosol upon activation of a trigger device.
iv. an audio output system integrated with said main body and adapted to play a sound.

2. An aerosol dispensing unit according to claim 1, wherein said audio output system is adapted to play said sound in response to the activation of said trigger device.

3. An aerosol dispensing unit according to claim 1, wherein said audio output system is adapted to play said sound at pre-determined timed intervals.

4. An aerosol dispensing unit according to claim 1, further comprising a sensor to detect a person, and wherein said trigger device is activated upon detection of said person.

5. An aerosol dispensing unit according to claim 1, comprising a timer operatively connected to said trigger device to dispense said metered amount of said aerosol and play said sound at timed intervals.

6. An aerosol dispensing unit according to 1, further comprising a memory unit for storing at least one audio message, and wherein said sound is selected from said at least one audio message.

7. An aerosol dispensing unit according to claim 6, further comprising a programming device in communication with said memory unit for programming the selection of said sound from said at least one audio message on said memory unit.

8. An aerosol dispensing unit according to claim 7, wherein said at least one audio message comprises a plurality of audio messages, and said programming device is programmed to select said sound from said plurality of audio messages each time said trigger device is activated.

9. An aerosol dispensing unit according to claim 8, wherein said sound is selected based on a random selection, a sequential selection, a pre-determined ordered selection, a timed selection, or some combination thereof, of said plurality of audio messages.

10. An aerosol dispensing unit according to claim 9, wherein said plurality of audio messages comprises one or more of an advertisement, a sanitary-related reminder message, a safety reminder message, an informative message, or a combination thereof.

11. An aerosol dispensing unit according to claim 7, further comprising a recording device integrated with said main body, and operatively connected to said memory unit, for recording said at least one audio message.

12. An aerosol dispensing unit according to claim 1, wherein said aerosol is one of a deodorizing agent and a disinfectant.

13. An aerosol dispensing unit according to claim 6, further comprising a wireless communication device for receiving said at least one audio message.

14. An aerosol dispensing unit according to claim 13, wherein said at least one audio recording is broadcast live to said wireless communication device and played via said audio output system.

15. An aerosol dispensing unit according to claim 7, further comprising an interface for connecting said programming device to a computer.

16. An aerosol dispensing unit according to claim 7, comprising a spray counter, in communication with said reservoir and said programming device, for counting the number of times the trigger device has been activated; said programming device adapted to determine the amount of aerosol remaining in said reservoir based on the number of times the trigger device has been activated; and said programming device is programmed to indicate a low level of aerosol remaining by one of a visual indicator and an audio message.

17. An aerosol dispensing unit according to claim 13, wherein said at least one audio message received by said wireless communication device comprises one of an advertisement, a news broadcast and a radio station feed.

18. An aerosol dispensing unit according to claim 4, further comprising a programming device in communication with said sensor, said audio output system, and said trigger device, said programming device adapted to:
(a) determine the presence of a person in an area from the sensor detection,
(b) activate said trigger device for a pre-determined time.
(c) initiate said sound playing from said audio output system.

19. An aerosol dispensing unit according to claim 18, wherein said programming device is further adapted to:
(d) produce a delay prior to determining the presence of another person,

20. An aerosol dispensing unit according to claim 18, wherein said programming device is further adapted to:
(d) determine the absence of said person from said area.
(e) stop said sound playing from said audio system,
(f) determine the presence of a subsequent person in said area,
(g) activate said trigger device,
(h) initiate said sound playing from said audio output system.
(i) repeat steps (e) to (i).
